(19) United States
(12) Patent Application Publication
(10) Pub. No.: US 2008/0035750 A1
(43) Pub. Date: Feb. 14, 2008

(54) Reduction of cyclonic wind damage

(76) Inventor: Robert Benson Aylor, Blue Ash, OH (US)

Correspondence Address: ROBERT B. AYLOR, 9502 BLUEWING TERRACE, CINCINNATI, OH, 45241, US

(21) Appl. No.: 11/706,676

(22) Filed: Feb. 15, 2007

Related U.S. Application Data
(60) Provisional application No. 60/800,885, filed on May 16, 2006.

(51) Int. Cl. A01G 15/00

(52) U.S. Cl. 239/2.1

(57) ABSTRACT

The damage from cyclonic winds is reduced by (1) providing another source of air for the center of the cyclonic wind from outside the system, the air desirably being cooler and denser to minimize the tendency of the air to flow upward; (2) by “plugging” the center of the cyclonic wind to prevent the upward flow of air in the center or the downward flow of air around the inside wall of the cyclonic wind, e.g., by countering the upward flow in the center or by countering the downward flow around the inside of the cyclonic wind flow; and/or (3) by slowing the cyclonic wind directly thus diminishing the flow of air and the ability of the cyclonic wind to form a wind wall.

This application claims priority from my Provisional Patent Application Ser. No. 60/800,885, filed May 16, 2006.

### BACKGROUND OF THE INVENTION

Cyclonic winds like tornados and hurricanes can cause considerable damage. The force of cyclonic winds requires a low pressure in the center of the cyclonic wind that is created by an upward flow of air due to the air in the center at the surface being lighter as a result of being wanner and lighter than the air above. The structure of a cyclonic wind is analogous to the swirl around a drain in the bathtub. In the bathtub, the water swirls around in a downward spiral until the water finally disappears down the drain. In a cyclonic wind, the air swirls around the center of the cyclonic wind in a downward spiral until it reaches the bottom that is sealed by the earth, whereupon the air, having nowhere else to go, rises through the center of the cyclonic wind due to it being lighter than the air at the top of the cyclonic wind. The air that rises is replaced by air that has spun around the center on its way to the bottom of the cyclonic wind in a vortex. The vortex of air whirling around the center creates a “wind wall” separating the interior of the cyclone from the outside to maintain stability. In addition, the centrifugal force created by the swirl helps decrease the density of the air in the center, since warm air, that is lighter, preferentially remains in the center as the centrifugal force moves the heavier, colder air to the outside of the vortex. Dust devils are small versions of cyclonic winds that usually do only minimal damage. The model for the dust devil is that a localized heating at the ground causes a rising column of hot air that pulls air into the column. The resulting flow of air up the column is maintained by a descending circular vortex of air that defines the dust devil. Some tornados generate like dust devils, e.g., superheated air, heated by a series of lightning strikes, especially lightning strikes that are grouped closely together, starts rising in a column and the resulting flow of air that replaces the rising superheated air creates a vortex. Some of these tornados are extremely dangerous, since they are difficult to detect until the vortex builds to a height where radar can detect the vortex.

### FIELD OF THE INVENTION

The invention relates to reducing the damaging effects of cyclonic winds by disrupting the stability required to maintain the cyclonic wind.

### DESCRIPTION OF RELATED ART

It has been suggested that the cyclonic vortex winds that help maintain the cyclone could be disrupted by explosive blasts, but there has been no confirmation of this thesis due to the difficulties in actually delivering an explosive to the appropriate location, especially without causing other problems and endangering lives or property. It has been suggested that one might use a “dust devil” as a model for experimenting with cyclonic winds, but there is no indication that this has ever been tried.

The suggestions of the use of explosives to disrupt cyclonic winds include the suggestion that atomic bombs be dropped on hurricanes and a recent suggestion that very large bombs like the “MOAB” (mother of all bombs) used in Afghanistan could be used on hurricanes to disrupt the hurricane. The general consensus for hurricanes is that the force of the hurricane is too great to be affected by any such explosion and the harmful effects of radiation from an atomic explosion would not be acceptable. Suggestions of using explosives on, tornados have been dismissed because of the difficulty of delivering the explosives. Additionally, there is potential damage to structures and people on the ground, since tornados occur primarily over land, with the exception of “water spouts”.

### BRIEF SUMMARY OF THE INVENTION

As stated above, cyclonic winds comprise rising air in the center of the swirling cyclonic wind that is replaced by air that reaches the earth after following a circular descending path from above to the ground along the interior of the rapidly spinning cyclonic wind which forms a wind wall. In the stable configuration, this rising air can only be replaced by the air from the wall of the cyclonic wind at the bottom of the swirling cyclonic wind since the cyclonic wind is sealed at the bottom by the earth.

The disruption of the cyclonic winds that form a tornado or hurricane can be accomplished by interrupting this stable flow of air. This disruption can diminish the cyclonic wind and thereby diminish the damage caused by a cyclonic wind. The flow can be interrupted by: (1) providing another source of air for the center of the cyclonic wind from outside the system, the air desirably being cooler and denser to minimize the tendency of the air to flow upward; (2) by “plugging” the center of the cyclonic wind to prevent the upward flow of air in the center or the downward flow of air around the inside wall of the cyclonic wind, e.g., by countering the upward flow in the center or by countering the downward flow around the inside of the cyclonic wind flow; and/or (3) by slowing the cyclonic wind directly thus' diminishing the flow of air and the ability of the cyclonic wind to form a wind wall. Combinations of these approaches can be especially useful for large cyclonic winds like hurricanes.

### BRIEF DESCRIPTION OF THE DRAWINGS

FIG. 1 is a side view of a tornado vortex that is positioned over a standpipe connected to an underground passageway.

FIG. 2 is a side view of the eye wall of hurricane with a submerged passageway reaching from outside the center of the hurricane to the center of the hurricane.

FIG. 3 is a plan view of a tornado vortex showing the direction of a focused explosive blast.

FIG. 4 is a side view of a tornado being penetrated by a rocket to deliver an explosive with the explosion being directed down the tornado center.

FIG. 5 is a plan view of the eye wall of a hurricane with a representation of a barge and explosive blasts directed against the force of the wind at the eye wall.

FIG. 6 is the plan view of a hurricane with a ring of incendiary devices disposed around the eye wall at the top of the eye wall.

### DETAILED DESCRIPTION OF THE INVENTION

(1) Providing Another Source of Air for the Center of the Cyclonic Wind from Outside the System.

Providing another outside source of air to replace the air rising from the bottom of the center of the cyclonic wind can have several results that reduce the flow of air and/or destabilize the cyclonic wind. Additional air from the other source can raise the pressure and density and/or lower the temperature of the air at the bottom of the center of the cyclonic wind. Higher density air does not have the same tendency to rise and the higher density and pressure inhibits the air from the inside of the cyclonic wind from flowing to the center, thus slowing the circular flow in the vortex, at least temporarily. Raising the density of the air in the center of the cyclonic wind at the surface, e.g., by lowering the temperature of the air in the center of the cyclonic wind at the surface, by providing additional air, can stop or slow the flow of air from the inside of the cyclonic wind wall up the center of the cyclonic wind, which stops or slows the downward circular flow required for stability.

Even a short interruption in the flow of air from the bottom to the top of the cyclonic wind's center will slow or stop the cyclonic flow resulting in a disruption of the steady state required to maintain the cyclonic flow.

Air can be provided to the center of the cyclonic wind by creating a tunnel, either by an explosion or by providing an actual tunnel that allows outside air to enter the center of the cyclonic wind. Disrupting the flow of air around the cyclonic wind's center by an explosion not only creates a tunnel, it also can effectively reduce/eliminate the “wall” effect of the cyclonic flow. In any event adding air inhibits the air that is circling the center of the cyclonic wind from escaping up the center of the cyclonic wind and slowing the upward flow of air from the cyclonic wind's wall slows the wind in the cyclonic wind's wall, thus reducing the force of the cyclonic wind and thereby reducing the damage resulting from the cyclonic wind.

(2) Plugging the Center of the Cyclonic Wind to Prevent the Upward Flow of Air in the Center or the Downward Flow of Air Around the Inside Wall of the Cyclonic Wind.

The center of the cyclonic wind can be “plugged” by using direct force to slow/stop the current of air rising in the center of the cyclonic wind.

An explosion, directed downward in the center of a cyclonic wind can slow or stop the upward flow. I.e., direct force can create a “plug”. The force of an explosion directed downward in the center of the cyclonic wind, especially a tornado, which has a smaller diameter, can slow or stop the upward flow, thus destabilizing the cyclonic wind since the wall created by the cyclonic wind tends to contain the explosive blast and maximize the effect. A directed explosion is even better.

One can also plug the center by simply lowering the density, e.g., by raising the temperature of the air at the top of the cyclonic wind to create a “temperature inversion”. Incendiary devices can be used to raise the temperature at the top of a cyclonic wind thus creating a temperature inversion. As discussed hereinafter, this approach can be useful for very large cyclonic winds like hurricanes. The incendiary devices can be placed over the entire center or just around the inside edge of the center of the cyclonic wind at the top to keep cool dense air at the top of the cyclonic wind from starting the downward spiral.

Reducing the upward flow of air in the center of the cyclonic wind, e.g., by force and/or by creating a localized temperature inversion or “plug”, destabilizes the cyclonic wind.

(3) Slowing the Cyclonic Wind Directly Thus Diminishing the Flow of Air and the Ability of the Cyclonic Wind to Form a Wind Wall.

This approach uses direct force to slow the cyclonic wind. Typically, this approach involves the use of explosives. However, it is also possible to provide large wall structures perpendicular to the flow lines that will have a similar effect.

(4) Multiple Approaches

Several of these approaches (1)-(3) can be accomplished by the use of explosive blasts, especially directed explosions such as those produced by “shaped” charges, directed into the center of the cyclonic wind and especially directed opposite to the direction of the winds at the base of the cyclonic winds (“near the surface”). A sufficiently large explosion can create a tunnel through the wind wall that allows air from the outside of the cyclonic wind to flow into the center of the cyclonic wind while also slowing or stopping the cyclonic wind that creates the wind wall. This air raises the density and/or pressure inside the cyclonic wind, and can lower the temperature of the air inside the cyclonic wind, thus reducing the flow of the air from the cyclonic wall which normally flows to the center and up the center of the cyclonic wind.

Each of these approaches works to destabilize the cyclonic wind. Reducing the wind speed around the cyclonic wind lessens the wall effect of the airflow in the vortex and allows outside, normally cooler, air from near the ground to penetrate the center more readily.

As discussed above, the circular flow of air around the center can separate denser cool air from lighter warm air by centrifugal action, thus reducing the speed of the flow allows cooler air to move back toward the center. However, it is especially desirable to have the cooler air forced into the center by an explosive blast that uses a projectile, e.g., a large number of small particles, to transfer the energy of the blast, with entrained, preferably cooler, air into the center of the cyclonic wind. This approach minimizes the heating of the air in the center of the cyclonic wind by the explosion that could actually increase the strength of the cyclonic wind. An explosion outside the cyclonic wind center primarily heats outside air. Utilizing solid materials, especially relatively non-lethal, finely divided, solid materials, as a way of transmitting energy into a cyclonic wind is effective in maintaining a directed force, since the particles tend to move in a straight line and carry entrained air with them. When the explosion is directed against the cyclonic wind it can slow or stop the cyclonic wind. It can also influence the wind to go straight, thus destroying the spiral.

Introducing a cooling medium into the center of a cyclonic wind can help lower the temperature of air in the center. One option is to use dry ice, especially in finely divided form, as a projectile, which can be shot into the center of the tornado to lower the temperature inside the tornado and increase density as it converts from a solid to a gas. Introducing the cooling medium in this way also can create a tunnel.

Explosives can be used to deliver cooling mediums such as dry ice into the center of a cyclonic wind such as a tornado at the base of the tornado. As discussed above, an appropriate cooling medium like finely divided dry ice can also act as a projectile to entrain air. The combination of reducing wind speed by an explosive blast directed against the direction of the wind flow and the cooling resulting from cool air entering the center, is augmented by the additional cooling provided by delivering a cooling medium to the center of the cyclonic wind.

The present invention, in one aspect, especially relates to either creating explosions at the base of cyclonic winds to direct the majority of the force of the explosion opposite to the direction of the winds at the interior of the cyclonic wind near its base to slow the wind and especially into the center of the cyclonic wind to disrupt the wind vortex around the center while creating a tunnel into the center and/or delivering cooler air into the center and/or raising the density in the center and/or by delivering cooling means such as dry ice into the center of the cyclonic wind. In another aspect, the explosion can be directed down the center of the cyclonic wind to forcibly stop the upward flow for a sufficient period of time to disrupt the cyclonic flow. This approach is more applicable to tornados where the time required to affect the flow is relatively short.

The invention in another aspect also comprises raising the temperature at the top of the cyclonic wind, e.g., by explosions or providing heat by combustion to lower the density and thus slow the essential downward spiral flow of air around the edge of the center of the cyclonic wind as well as decreasing the upward flow of air. It is well known in meteorology that temperature inversions are stable.

When the air in the wind at the edge of the center of the wind contains moisture, e.g., as in a hurricane, distributing inorganic salts such as anhydrous sodium sulfate, having high negative heats of crystallization with water at the temperature of the air, into the air near the base of the cyclonic wind can effect cooling by absorbing heat and increase air density by removing water vapor.

An explosion can augment the effect of such an inorganic salt that forms a hydrate by spreading the salt rapidly throughout the cyclonic wind and/or its center and/or by allowing the rapidly moving inorganic salts to entrain cooler air and deliver it to the center of the cyclonic wind. The heating effect of the explosion can be limited by discharging the inorganic salts using an explosion outside the cyclonic wind, and conveying the energy of the explosion to the center of the cyclonic wind by transferring the explosion's energy to create kinetic energy in the inorganic salt. As a practical matter, projectiles that are finely divided particles do not usually carry a great distance, thus using an explosion outside the cyclonic wind is normally limited to tornados.

Physical “Tunnels”

As previously mentioned, one can raise the density in the center of a cyclonic wind by creating an actual passageway to allow air from outside the cyclonic wind to enter the center which reduces the speed of the air in the vortex wall since the air in the wall now has to compete with the air from outside the vortex wall.

For tornados, one can provide such actual passageways, e.g., through pipes or underground tunnels, with openings both inside and outside the center of the cyclonic wind, said passageways allowing air, desirably cooler air, to pass from outside the tornado to inside the tornado. This approach is shown in FIG. 1, where the tornado 21 is positioned with the center of the vortex 22 over one of a series of stand pipes 23-a, b, and c which are connected underground by a tunnel 24, the arrows 25 showing the flow of additional air into the center of the tornado vortex 22.

Since such an approach requires substantial structures, it is desirable to use such a structure only for defending very expensive targets or where the structure has some other use, e.g., storage. Large industrial complexes are such expensive and would justify considerable expense for creating a defense. Providing a long underground tunnel that is capable of storing water can provide an additional benefit, i.e., the storage of water. In addition, the flow of air over the cool water provides cooler air to the center of the cyclonic wind. In order to allow air to flow through the tunnel, one would provide a series of “standpipes” that would allow air to flow down standpipes outside the cyclonic wind and up through standpipes inside the center of the cyclonic wind to temporarily raise the density in the center of the cyclonic wind, depriving the cyclonic wind of the energy needed to maintain the wind flow.

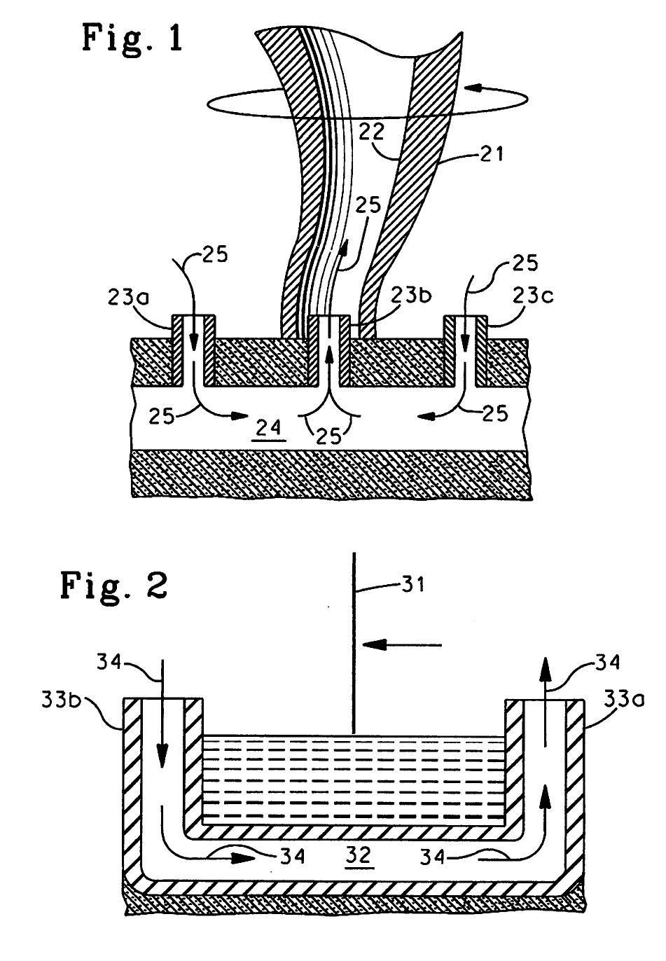

For hurricanes, the passageway can be through pipes, especially under the water, with openings both in the eye of the hurricane and outside the eye wall, where cooler air and higher density are present. This approach is shown in FIG. 2 where the eye wall 31 of a hurricane is crossed by a submerged pipe 32 stretching from inside the eye wall to outside the eye wall with an opening 33a inside the eye wall and an opening 33b outside the eye wall. Cooler, denser, air passes through the passageway 32 in the direction shown by the arrow 34, from the outside of the eye wall to the center.

Delivery of Explosives

With respect to tornados, it is surprising, given the long standing need to reduce the damage from tornados and the existence of suggestions to use explosives, that there has been no suggestion that an explosion, either from an explosive device or a device like a cannon, can be delivered either by, e.g., a rocket, or a large cannon, etc., fired directly at the cyclonic wind, or from a moving vehicle, particularly an aircraft. Drone aircraft have been available for some time and the development of sophisticated drones such as the Predator drone means that an unmanned aircraft can be used to effectively deliver an explosive without risking human life. Such drones could use rockets or cannons to deliver the explosive.

There are many publications which provide disclosure of missiles including U.S. Pat. No. 5,430,449, issued Jul. 4, 1995, Frazho, et al. and the other publications and patents referred to therein, all of such patents and publications being incorporated herein by reference.

Fixed positions could also be used for such defense against tornados, especially for cities and large industrial complexes, analogous to antiaircraft emplacements used to protect similar targets against bombers. The Patriot missiles used for missile defense could be modified readily to serve this purpose. Missile launchers for such missiles and their missiles can be moved from place to place as needed so that they are not truly “fixed”. Alternatively, airborne missiles can be used to deliver explosives. In any event, the time from detection of a tornado to the time when damage can occur is very short. Therefore, it is important to have the means for controlling the cyclonic wind close to the point where tornados are expected. This can include sites on the ground and aircraft in the air that have such means ready for delivery.

Therefore, in one aspect of the invention, devices to deliver explosives to a tornado are placed in strategic areas. One advantage of this approach is to provide training for placing and delivering explosives that can be adapted to placing and delivering explosives to counter, e.g., missiles that are directed at strategic areas. The same skills used to detect tornados and destroy them can be put to use by defensive forces in the event of an attack by an unfriendly force. The use of rockets to deliver explosives is useful in that the speed of the rocket is added to the speed of the focused explosion to make a given size of explosive even more effective.

Again, it is very surprising that directed forces such as those delivered by shaped charges or from some form of gun have not been suggested for use against tornados, hurricanes, etc., since they limit the collateral damage from the explosion and make more efficient use of the explosives. In one alternative it can be useful to provide a gun with a barrel configured like a blunderbuss to spread the explosive effect. A directed explosion, especially an explosion without lethal projectiles is only capable of damaging people or things in a limited area and only until the explosive force is dissipated. The force is dissipated fairly quickly in most instances. It is especially desirable to have some kind of relatively non-lethal material as a projectile to carry the force of the explosion, as discussed before. Such materials include finely divided salts, sand, dry ice, ice, light plastic pellets, etc.

The improvement in radar detection of tornados that has occurred recently improves the chances of locating and reaching a tornado before it reaches large commercial installations, large cities, etc. Given the cost of the potential damage from a tornado, it can be cost effective to create “anti-tornado” rocket installations to be used when tornados threaten damage to a specific installation or city. The size of the explosion does not have to be so great as to produce collateral damage to objects below and around the explosion, especially if the explosion is directed and/or focused, as can be accomplished by shaped charges or some type of gun. Thus, in one aspect, the method of reducing the damage from cyclonic winds involves detection of the tornado by Doppler radar. Doppler radar can be used to trigger the explosion when the cyclonic wind is in close proximity.

The detection of tornados has been disclosed in numerous patents, including U.S. Pat. No. 6,204,761, issued Mar. 20, 2001, Vanderable and US RE 33,152, issued Jan. 23, 1990, Atlas, and the other patents and references referred to therein, all of which are incorporated herein by reference.

Drones and/or rockets can be used to deploy incendiary devices. For large tornados or hurricanes, this approach can be very effective. The incendiary device can lower the density of the air. Raising the temperature creates a localized temperature inversion that plugs the center of the cyclonic wind. Lighter air does not sink along the edge of the cyclonic wind and the rising air from the center of the cyclonic wind at the surface cannot readily rise into a lighter air mass.

Directed Explosions.

As discussed before, the explosion can slow or stop the winds forming the internal wall of the cyclonic wind and/or drive cooler air into the center of the cyclonic wind. Once the wall created by the moving air around the center of the cyclonic wind is destroyed or compromised, even in a small area near the base, the density in the center of the cyclonic wind can be raised and/or the temperature of the air in the center can be lowered, by a straight line wind from the outside, thus either slowing the upward velocity of air in the center of the cyclonic wind or reducing the amount of air from the wall of the cyclonic wind that can enter the center of the cyclonic wind, thereby reducing/ending the creation of the energy required to maintain the cyclonic wind flow. Directed explosions are extremely useful. The wall can be destroyed by directing the explosive force either toward the wind or directly into the center of the wind.

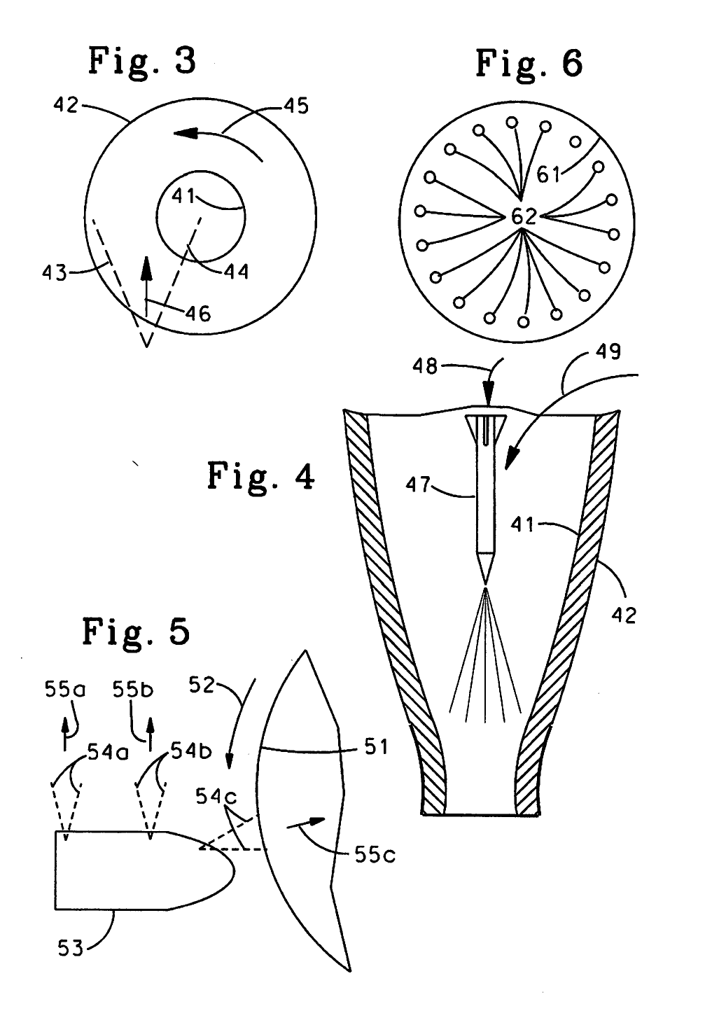

The use of an explosion can be better understood by reference to FIG. 3 which shows the top view of a tornado defined by inner circle 41 and outer circle 42 with the dotted lines 43 and 44 defining the approximate sides of a focused explosive blast directed into the vortex against the wind, the arrow 45 indicating the direction of the wind flow in the tornado and the arrow 46 indicating the direction of the explosion.

When cooling medium such as dry ice is delivered by explosive, the cooling medium in the center of the tornado will help reduce the updraft responsible for the creation and maintenance of the cyclonic flow.

Shaped charges are well known and they are used in warfare to maximize the damage to targets and in the oil industry to maximize the effect of explosives used to fracture underground layers holding oil. An example of such a device is found in U.S. Pat. No. 6,983,698, Walters et al., issued Jan. 10, 2006 that recites several patents relating to such devices. The present invention provides another large potential use for such explosive devices where the force is delivered without lethal projectiles and, optionally, with cooling projectiles such as dry ice, inorganic salts, etc., as discussed hereinbefore, etc.

Although a gun can be used to direct an explosion, shaped charges are especially desirable, since the shaped charges can be delivered, using rockets, to a point where they can be detonated and the rockets do not need to carry the weight of a gun barrel, etc. Shaped charges can be created in a variety of sizes, but the size required for a particular tornado cannot be calculated with any degree of accuracy in advance. It will be desirable to have a selection of charges including one large enough to destroy an F5 tornado and have a margin of error. The force created by an F5 tornado would be the largest force expected. To destroy a sufficient part of the wall of the tornado to allow the outside pressure to raise the density inside the tornado, thus eliminating the mechanism by which the tornado generates the cyclonic flow, requires an explosive force of unknown magnitude, but one that can be approximated by doing some research, which can be accomplished with tornado generators or by destroying “dust devils”.

Some calculations of the maximum force required to disrupt the flow of air in a tornado can be made by solving for ½ mv² where m is the weight of the air and v is the velocity. For example, an approximately 100 meter cube of air, using an air density of 1.2 kg per cubic meter, would weigh about 1,200,000 kg., and when moving at about 500 kilometers per hour would have a kinetic energy of about 1.1×10¹⁰ joules. The explosive force needed for stopping this mass totally, would be the equivalent of about 2.5 tons of TNT, an explosive charge that can well be delivered by a rocket. It is unlikely that this total amount of energy would be required, and for smaller tornados, the energy needed would be much less.

Another way of providing an explosive force for countering the cyclonic wind flow, especially for small tornados, is by means of a force created by a rapidly moving object. A “sonic boom” created by an airplane flying on the side of a tornado in the opposite direction of the air flow will create a momentary force that will weaken the wind speed and allow the pressure outside the tornado to increase the density inside the tornado.

Yet another potentially more effective method of using explosives against tornados involves directing the explosion down the funnel of the tornado to stop the upward flow of air. As shown in FIG. 4, one can use a high-flying airplane or rocket to direct an explosion down the center of a tornado. A rocket is an especially desirable piece of equipment for delivering an explosive, since it can penetrate the wind wall at the top or even at an intermediate level as shown in FIG. 4, where the rocket 47 either follows the path shown by arrow 48 downward from the top of the tornado defined by the outside 42 and the inside 41, or follows the path shown by the arrow 49 where the wall of the tornado is penetrated by the rocket 47 to direct the explosion down the inside of the tornado.

Thus, in one aspect, the invention relates to using a rocket to deliver an explosive to the center of a tornado.

Hurricanes

Hurricanes are much larger than tornados, thus they pose a more difficult problem when attempting to control them. Although an explosive can be delivered by aircraft to a hurricane, the inner wind wall, conventionally referred to as the “eye wall”, of a hurricane, is so large that it is more cost effective to transport the explosive by watercraft. To minimize the amount of explosive needed, the explosive force should be delivered near sea level and at or near the point where the wind speed is fastest, i.e., the eye wall. The eye wall of the hurricane is an optimum place to slow and/or disrupt the winds. This approach is shown in FIG. 5 where 51 is the eye wall of a hurricane with the direction of the wind being indicated by arrow 52 with a floating barge 53 positioned at the eye wall and with the pairs of dotted lines 54a, b, and c, representing multiple focused explosive forces directed along the directions of the arrows 55a, b, and c, into the wind that creates the eye wall. The arrow 55c is directed toward the center of the hurricane, in this depiction, to help the movement of cool air into the center of the hurricane.

A submarine or a drone ship can deliver an explosive device without having to risk death to individuals from the waves, the explosion, etc. The submarine, or a surface vessel, can be directed to the proper position by either direct means or the use of inertial guidance systems. One effective way to position a vessel with the ability to submerge is to submerge it in the path of the hurricane and then raise it at the proper time. Watercraft are superior to aircraft for delivering the amount of explosive needed and can deliver the explosive force at the surface where disruption of the cyclonic wind will be more effective. The explosive force needed to disrupt even a small segment of the eye wall of a hurricane will be many thousands of tons of TNT. The suggestion of using a MOAB against a hurricane would not be desirable, unless the MOAB could be turned before the explosion and the explosion could be created near the surface of the ocean to direct the force against the cyclonic flow near the ground or the MOAB is used at a high altitude to raise the temperature of the air above the center of the hurricane as discussed hereinafter.

It is true that the force of a hurricane is much greater than any man made explosion that is practical, and it is unlikely that any explosion will permanently destroy a hurricane. However, a directed explosion near the center can create eddies, disrupt the organization of the flow around the center, and/or create a tunnel. When the maximum effective winds are disrupted for even a relatively short period of time the outside pressure will be able to move air into the center of the hurricane through the resulting “tunnel”, especially if the explosive force is directed in part toward the center of the hurricane, to raise the density and/or cool the air in the center. Accordingly, the explosion will desirably be created close to shore and immediately before the hurricane's landfall, so as to allow only a short time for the hurricane to reorganize and intensify.

In order to maximize the effect of the explosion, one can use the explosion to spread a cooling medium like dry ice or a salt like anhydrous sodium. Sodium sulfate decahydrate has a melting (hydration/dehydration) point of about 32° C. and a latent heat of about 60 cal/g. Thus, when anhydrous sodium sulfate is exposed to water at a temperature of less than about 32° C., the salt can form the hydrate and absorb this amount of energy. Also, as the moisture is removed from the air when the hydrate is formed, the density of the air is increased since dry air is denser than moist air. Increasing the density also reduces the wind speed since that is necessary to maintain the same kinetic energy. This additional cooling can create cool air to flow into the center of the hurricane to lower the temperature as well as raise the density and the increased effectiveness of the explosion creates a bigger “tunnel”. The combined effect of the explosive force which disrupts the stable wind configuration at the eye wall that acts to maintain the low pressure in the center “eye” of the hurricane and the effect of the cooling at the eye wall can increase the density and lower the temperature in the center to diminish the upward air flow that generates the force of the hurricane. The hurricane will then have to reorganize.

Although the total amount of energy represented by a hurricane is much greater than any explosion, the extent of damage caused by the hurricane is related to the maximum winds present in the eye wall. Disruption of the eye wall wind currents and/or increasing the density and/or lowering the temperature in the center of the hurricane will reduce the maximum sustained wind speed for a period of time which will be sufficient to reduce the damage on shore so long as the disruption is timed to occur shortly before, e.g., the hurricane makes landfall or before it reaches a valuable asset like a collection of drilling rigs out in the ocean.

The place in the eye wall where the explosion occurs can affect the direction of the hurricane subsequent to the explosion. Since there is a low pressure in the center of the hurricane, the winds created by the filling of the low pressure from the direction where the eye wall is disrupted can move the hurricane away from the point of the explosion and generally in the direction of the force of the explosion. Multiple explosions on both sides of the eye wall can balance out this effect. However, the greatest disruption for a hurricane about to make landfall should be on the side where the hurricane winds are directed toward the land mass. A disruption on the side where the winds are directed away from the land mass can move the hurricane ashore sooner. Depending on the circumstances, this can be the most desirable option. Therefore, an important aspect of the invention is the use of explosives to steer the hurricane while desirably limiting the damage. This can allow one to end a drought, even when the hurricane is going to steer away from landfall.

The amount of explosive and the weight of the explosive needed for a hurricane makes watercraft the least expensive option for a delivery system. A preferred explosive from a safety and cost standpoint is ammonium nitrate and a desirable cooling medium is anhydrous sodium sulfate since it does not have to be cooled constantly like dry ice. The amounts of each will desirably be in tons, even hundreds or thousands of tons with the explosion being directed up and into the wind to disrupt the maximum area of the wind at the eye wall of the hurricane and to cool the maximum volume of air at the eye wall.

The kinetic energy needed to affect the hurricane at its eye wall will have to disrupt a relatively large area as compared to what is required for a tornado. For a volume of air that is a kilometer wide and 100 meters high the mass will be about 120,000,000 kg and the kinetic energy required will be about 2.9×10¹¹ joules or about 57 tons of TNT. This estimate is probably on the low side, but an explosive force on the order of hundreds or thousands of tons of TNT can slow the wind speed to a point where the outside pressure can raise the density of the center of the hurricane and diminish the maximum wind speed. In effect, the explosion creates a “tunnel” through the eye wall that permits cooler, high-density air to enter the eye of the hurricane.

When anhydrous sodium sulfate is used as a “projectile”, the effect of removing a great deal of heat and water vapor from the air will augment the effect of the explosion. The sodium sulfate particles will carry the energy further into the approaching air mass to slow the air molecules that are approaching and reduce their speed by raising the density of the air mass. It should be noted that the air does not have to be stopped, but merely slowed, in order to diminish the damage.

It is desirable to discharge the explosives from any vessel that delivers the explosives before the main charge is ignited to avoid damage to the vessel or vessels. It is also desirable to discharge the explosives as a plurality of charges to minimize the effect on the vessels or vessels. Using a plurality of charges allows for the possibility to extend the effect and/or change the direction of the explosive force in each explosion. It can be desirable to discharge the last few explosions in the direction of the center of the hurricane to direct the wind from the outer portion of the eye wall into the center, thus maximizing the increase in density and the reduction in temperature of the center of the hurricane.

It is also possible to raise the temperature and thus decrease the density at the top of the eye of a hurricane by a large explosion and/or incendiary devices. A MOAB exploded at the center of an eye at a very high level with incendiary devices being scattered over much of the area of the eye can raise the temperature and/or the density substantially for a short time. However, it is also possible to spread incendiary devices only at the edge of the eye wall near the top of the eye wall where the down flow of air that forms the vortex of the eye wall originates to form a localized inversion. The optimum positioning of such incendiary devices is where the downward flow originates. This location can be readily detected by use of one or more smoke bombs. This approach is shown in FIG. 6 where there is an eye wall 61 and a ring of incendiary devices 62 that are deployed near the top of the eye wall to heat the air and create a localized inversion.

It is not necessary to completely destroy a hurricane to minimize damage, and, in fact, it is not desirable to completely destroy a hurricane, since hurricanes are important agents for transporting fresh water onto the land. Therefore, it is desirable to diminish the maximum wind speeds just before the hurricane comes ashore.

Again, it should be noted that slowing the wind in the eye wall of a hurricane can tend to influence the direction of movement of the hurricane, typically in the direction of the explosion used to slow the air movement in the eye wall.

What is claimed is:

1. A method for reducing the damage from a cyclonic wind, said cyclonic wind comprising: a center; a descending vortex of wind creating a eye wall of wind around said center; and an upward flow of air in said center, where said eye wall defines the outer boundary of said center, said cyclonic wind at the surface possessing a lower pressure in the center as compared to the exterior of the cyclonic wind, said method comprising either: (1) providing another source of air for the center of the cyclonic wind from outside the system, the air optionally being cooler and denser to minimize the tendency of the air to flow upward; (2) by plugging the center of the cyclonic wind to prevent the upward flow of air in the center and/or the downward flow of air around the inside wall of the cyclonic wind; and/or (3) by slowing the cyclonic wind directly thus diminishing the flow of air and the ability of the cyclonic wind to form a wind wall.

2. The method of claim 1 comprising directing an explosive force against the eye wall of the cyclonic wind near its base.

3. The method of claim 2 wherein the said explosive force is delivered by a finely divided, relatively non-lethal, projectile.

4. The method of claim 3 wherein said projectile comprises at least one of inorganic salts, dry ice, and finely divided solids other than inorganic salts or dry ice.

5. The method of claim 4 wherein the cyclonic wind is a hurricane and the inorganic salt comprises finely divided anhydrous sodium sulfate.

6. The method of claim 5 wherein the explosive comprises ammonium nitrate.

7. The method of claim 2 wherein the explosive force is created by a shaped charge.

8. The method of claim 2 wherein said explosive force is created by an explosive device that is delivered by a mechanical drone and detonated.

9. The method of claim 2 wherein the explosive force distributes a cooling means into the center of said cyclonic wind.

10. The method of claim 9 wherein the cooling means is dry ice.

11. The method of claim 9 wherein the cooling means is finely divided anhydrous sodium sulfate.

12. The method of claim 2 wherein said cyclonic wind is a tornado.

13. The method of claim 12 wherein explosive devices are positioned in advance of the existence of the cyclonic wind to protect specific areas.

14. The method of claim 12 wherein an explosive device is delivered by a rocket to the center of the tornado.

15. The method of claim 12 wherein Doppler radar is used to detect said tornado.

16. The method of claim 1 wherein a passageway for air from outside the center of the cyclonic wind into the center of the cyclonic wind is provided.

17. The method of claim 16 wherein the cyclonic wind is a tornado and the passageway is an underground tunnel that optionally is used for water storage.

18. The method of claim 1 comprising raising the temperature and/or pressure at the top of the cyclonic wind.

19. The method of claim 18 wherein said cyclonic wind is a hurricane and the temperature and/or pressure are raised by deploying incendiary devices around the eye wall of the hurricane near the top of the eye wall.

20. A method for steering hurricanes comprising a center eye in which explosions are directed against the wind at the edge of the center eye.
